(19) United States
(12) Patent Application Publication
(10) Pub. No.: US 2008/0273342 A1
(43) Pub. Date: Nov. 6, 2008

(54) Track-Movable Lighting System

(75) Inventor: Kyung-Hwan Kim, Chungcheongnam-do (KR)

Correspondence Address: HOLLAND & HART, LLP, P.O BOX 8749, DENVER, CO, 80201, US

(73) Assignee: New Technology Bank Co., Ltd., Chungeheongnam-do (KR)

(21) Appl. No.: 10/597,174

(22) PCT Filed: Feb. 4, 2005
(86) PCT No.: PCT/KR2005/000317

§ 371 Date: Jul. 13, 2006

(30) Foreign Application Priority Data
Feb. 7, 2004 (KR) 10-2004-0008120

(51) Int. Cl. B60Q 1/00

(52) U.S. Cl. 362/459

(57) ABSTRACT

A lighting system freely moving along a track having trolley bars. The track-movable lighting system includes the track (10) fixedly installed on a ceiling of a structure; a plurality of transport units (20) installed on the track (10) so that the transport units (20) can move along the track (10) by means of motors (23); lighting devices (30) respectively installed on the transport units (20) so that the lighting devices (30) can move together with the movement of the transport units (20); and control devices for respectively controlling the movement of the corresponding transport units (20) and the operation of the corresponding lighting devices (30).

### TECHNICAL FIELD

The present invention relates to a lighting system, which moves along a track, and more particularly to a lighting system, which freely moves along a track having trolley bars.

### BACKGROUND ART

Conventionally, a large number of lighting devices are used in structures, such as indoor gymnasiums, auditoriums, halls, outdoor stadiums, and tunnels, and these structures have a common feature in that domes or ceilings of these structures are high. Since it is not easy to reach the lighting devices installed on the ceilings of the structures, the maintenance of the lighting devices is not easy and requires high costs and hard efforts.

Accordingly, when these structures are designed, in order to reduce the number of maintenance procedures of the lighting devices, a designer must install the lighting devices in greater number more than that required to obtain luminance needed by the structures, thereby allowing the lighting devices to maintain the minimum luminance even when the total intensity of illumination of the lighting devices is decreased by the failure of several lighting devices in use or collected dust.

Consequently, the conventional lighting device has several disadvantages, such as high-energy consumption rate as well as difficulty in installation and maintenance.

### DISCLOSURE

### Technical Problem

Therefore, the present invention has been made in view of the above problems, and it is an object of the present invention to provide a track-movable lighting system, which moves lighting devices installed on transparent units along a track having a guide rail installed on a ceiling of a structure and a plurality of trolley bars, and has an equipment for allowing a worker to repair and clean the lighting devices at a designated position in the structure, thereby supplying convenience in maintenance of the lighting devices to the worker and reducing energy consumption rate due to the installation of the lighting devices prepared in the necessary number.

### Technical Solution

In accordance with an aspect of the present invention, the above and other objects can be accomplished by the provision of a track-movable lighting system comprising: a track fixedly installed on a ceiling of a structure; a plurality of transport units installed on the track so that the transport units can move along the track by means of motors; lighting devices respectively installed on the transport units so that the lighting devices can move together with the movement of the transport units; and control devices for respectively controlling the movement of the corresponding transport units and the operation of the corresponding lighting devices, wherein: the track includes a guide rail fixed to the ceiling of the structure by a fixing member, and a plurality of trolley bars installed on the guide rail through insulators; each of the transport units includes a frame having a plurality of wheels, a motor installed on the frame for driving the wheels, a collector for transmitting electric power or a data signal, flowing along the trolley bars, to the transport unit, and an encoder for calculating the moving distance of the transport unit by means of the motor; and Each of the control devices includes a main control unit installed at a designated position of the structure, and a subsidiary control unit installed on the corresponding transport unit for controlling the movement of the corresponding one of transport units and the operation of the corresponding one of the lighting devices.

### ADVANTAGEOUS EFFECTS

The present invention provides a track-movable lighting system, which moves lighting devices installed on transparent units along a track having a guide rail installed on a ceiling of a structure and a plurality of trolley bars, and allows a worker to repair and clean the lighting devices at a designated position in the structure, thereby supplying convenience in maintenance of the lighting devices to the worker and reducing energy consumption rate due to the reduction in the number of the lighting devices.

### DESCRIPTION OF DRAWINGS

The above and other objects, features and other advantages of the present invention will be more clearly understood from the following detailed description taken in conjunction with the accompanying drawings, in which:

FIG. 1 is a partially sectional view of a track-movable lighting system in accordance with a first preferred embodiment of the present invention;

FIG. 2 is a side view of the track-movable lighting system of FIG. 1;

FIG. 3 is a side view of a carbon brush collector of the track-movable lighting system of FIG. 1;

FIG. 4 is a partially sectional view of a track-movable lighting system in accordance with a second preferred embodiment of the present invention;

FIGS. 5A and 5B are schematic views respectively illustrating the track-movable lighting systems of the present invention, which are applied to gymnasiums;

FIGS. 6A and 6B are schematic views respectively illustrating equipments for maintaining and repairing the track-movable lighting system of the present invention;

FIG. 7 is a schematic view illustrating the track-movable lighting system of the present invention, which is applied to a tunnel;

FIG. 8 is a partially sectional view of the track-movable lighting system of the present invention provided with dust protective covers; and

FIG. 9 is a side view of the track-movable lighting system of the present invention provided with the dust protective covers.

### BEST MODE

Hereinafter, a track-movable lighting system in accordance with a first preferred embodiment of the present invention will be described in detail with reference to the annexed drawings.

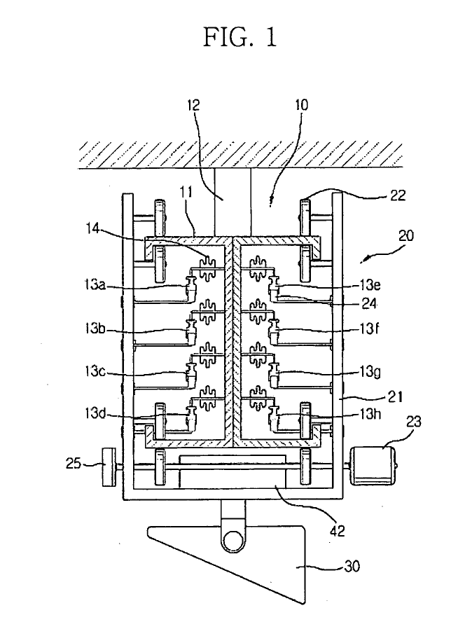

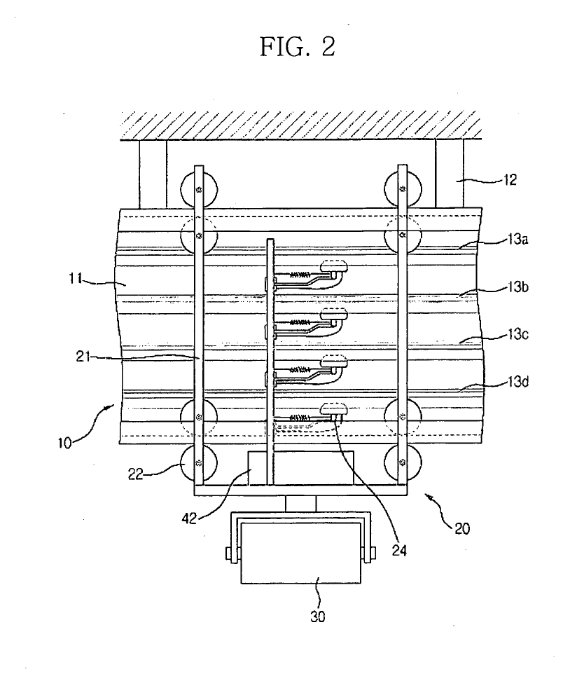

As shown in FIGS. 1 and 2, the track-movable lighting system in accordance with the first preferred embodiment of the present invention comprises a track 10 fixedly installed on a ceiling of a structure, a plurality of transport units 20 installed on the track 10 so that the transport units 20 can move along the track 10 by means of motors 23, lighting devices 30 respectively installed on the transport units 20 so that the lighting devices 30 can move together with the movement of the transport units 20, and control devices for respectively controlling the movement of the corresponding transport units 20 and the operation of the corresponding lighting devices 30.

The track 10 includes a guide rail 11 fixed to the ceiling of the structure by a fixing member 12, and a plurality of trolley bars 13a to 13h installed on the guide rail 11 through insulators 14.

Each of the transport units 20 includes a frame 21 having a plurality of wheels 22, a motor 23 installed on the frame 21 for driving the wheels 22, a carbon brush collector 24 for transmitting electric power or a data signal, flowing along the trolley bars 13a to 13h, to the transport unit 20, and an encoder 25 for calculating the moving distance of the transport unit 20 by means of the motor 23.

Although not shown in the drawings, the rotational velocity of the motor 23 is reduced by a reducer (not shown), but the increased rotary torque of the motor 23 is maintained, and is transmitted to the wheels 22. The reducer for performing the above operation is well known, and its detailed description will thus be omitted.

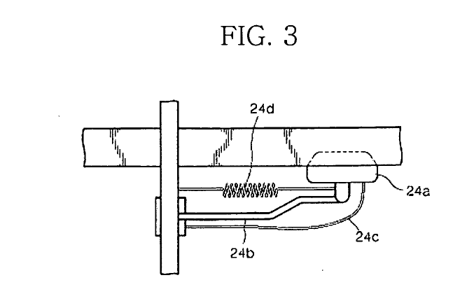

As shown in FIG. 3, the carbon brush collector 24 includes a slide member 24a sliding by electrical contact with the corresponding one of the trolley bars 13a to 13h, a support member 24b for supporting the slide member 24a to the frame 21 of the transport unit 20, a conductive wire 24c for electrically connecting the slide member 24a and the transport unit 20 so that the electric power or the data signal is transmitted therebetween, and an elastic member 24d for pressing the slide member 24a so that the slide member 24a firmly contacts the corresponding one of the trolley bars 13a to 13h.

Each of the control devices includes a main control unit (not shown) installed at a designated position of the structure, and a subsidiary control unit 42 installed on the corresponding transport unit 20 for controlling the movement of the corresponding transport unit 20 and the operation of the corresponding lighting device 30.

The guide rail 11 of FIG. 1 is produced by connecting steel materials having a C-shaped section. However, the guide rail 11 may be produced by connecting steel materials having an I-shaped section, and the present invention is not limited by the shapes of the guide rail 11.

Preferably, as shown in FIG. 1, four trolley bars are respectively installed at both sides of the guide rail 11 so that the total number of the trolley bars 13a to 13h is eight. If necessary, the number of the trolley bars may be modified.

In the case that the total number of the trolley bars 13a to 13h is eight, the four trolley bars 13a, 13b, 13c, and 13d serve as electric power lines, thereby supplying electric power of a designated voltage to the motor 23 of the transport unit 20 and the lighting device 30. The two trolley bars 13e and 13f serve as data communication lines, thereby allowing the main control unit and the subsidiary control unit 42 of the control device to communicate with each other. The remaining two trolley bars 13g and 13h serve as DC power supply lines, thereby supplying DC power to the subsidiary control unit 42.

The transport unit 20 freely moves to a designated position on the track 10 by instructions transmitted from the main control unit of the control device to the subsidiary control unit 42 of the control device through the trolley bars 13e and 13f serving as the data communication lines. That is, when movement instructions are transmitted from the main control unit to the subsidiary control unit 42 through the trolley bars 13e and 13f, the subsidiary control unit 42 operates the motor 23 installed on the transport unit 20, thereby moving the transport unit 20 along the track 10. Here, the moving distance of the transport unit 20 is measured by the encoder 25, and the measured distance of the transport unit 20 is transmitted to the main control unit through the trolley bars 13e and 13f, thereby allowing the main control unit to check whether or not the transport unit 20 moves by a desired distance.

Control instructions for controlling switching-on/off or angle of the lighting device 30 as well as the movement instructions for moving the transport unit 20 are transmitted from the main control unit to the subsidiary control unit 42 through the trolley bars 13e and 13f. In the same manner, the main control unit can check whether or not the control instructions are completed.

Preferably, a plurality of the transport units 20 installed on the track 10 are respectively controlled by the corresponding control devices.

All kinds of conventionally-used illuminators may be used as the lighting device 30. The lighting device 30 may be installed on the lower part or side surface of the transport unit 20. Further, the lighting device 30 may be fixedly installed on the transport unit 20, or may be rotatably installed on the transport unit 20 such that the angle of the lighting device 30 can be vertically and horizontally adjusted by a separate motor. In the case that the lighting device 30 is rotatably installed on the transport unit 20, the movement of the lighting device 30 can be voluntarily controlled by a user using the control device.

As described above, the lighting system of the present invention easily controls the lighting devices 30, thus being capable of flexibly lighting a stage when the lighting system is applied to the stage.

The above-described control device and a control method thereof are well known to those skilled in the art, and a detailed description thereof will thus be omitted.

In the track-movable lighting system of the present invention, preferably, the control device further includes a personal computer (not shown) for reading a current position value and a moving distance value of the corresponding transport unit 20 and a current lighting state and a position angle of the corresponding lighting device 30, or monitoring or instructing the selection of the position of the corresponding transport unit 20 and the selection of the angle of the corresponding lighting device 30.

As described above, the user can easily monitor data, such as the positions of the corresponding transport units 20 and the lighting states and position angles of the corresponding lighting devices 30 using the personal computers, thereby easily controlling the operation of the transport units 20 and the lighting devices 30.

Hereinafter, a track-movable lighting system in accordance with a second preferred embodiment of the present invention will be described in detail with reference to the annexed drawings. The track-movable lighting system of the second preferred embodiment differs from the track-movable lighting system of the first preferred embodiment in that the track-movable lighting system of the first embodiment comprises a plurality of the trolley bars arranged in parallel but the track-movable lighting system of the second embodiment comprises a plurality of trolley bars arranged in series. Thus, only the construction of the track-movable lighting system of the second preferred embodiment, differing from that of the first preferred embodiment, will be described as follows.

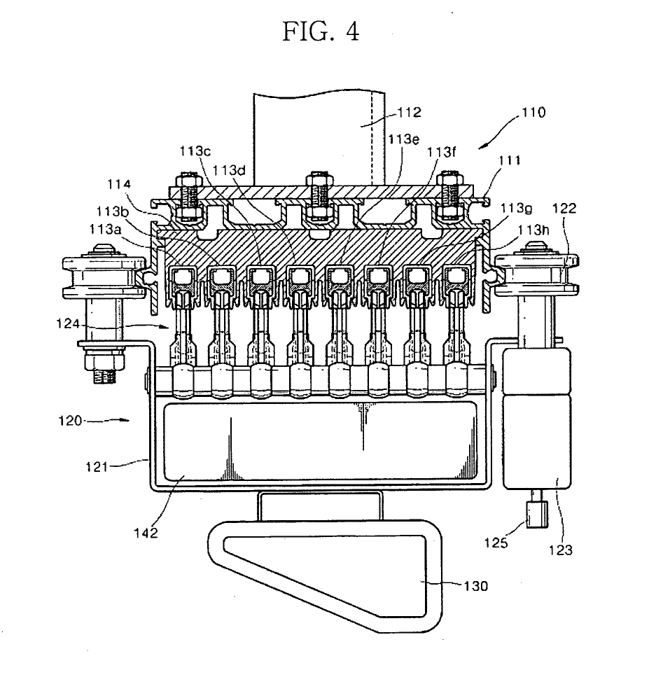

As shown in FIG. 4, in the same manner as the first preferred embodiment, the track-movable lighting system in accordance with the second preferred embodiment of the present invention comprises a track 110 fixedly installed on a ceiling of a structure, a plurality of transport units 120 installed on the track 110 so that the transport units 120 can move along the track 110 by means of motors 123, lighting devices 130 respectively installed on the transport units 120 so that the lighting devices 130 can move together with the movement of the transport units 120, and control devices for respectively controlling the movement of the corresponding transport units 120 and the operation of the corresponding lighting devices 130.

The track 110 includes a guide rail 111 fixed to the ceiling of the structure by a fixing member 112, and a plurality of trolley bars 113a to 113h installed on the guide rail 111 through insulators 114.

Each of the transport units 120 includes a frame 121 having a plurality of wheels 122, a motor 123 installed on the frame 121 for driving the wheels 122, a carbon brush collector 124 for transmitting electric power or a data signal, flowing along the trolley bars 113a to 113h, to the transport unit 120, and an encoder 125 for calculating the moving distance of the transport unit 120 by means of the motor 123.

Each of the control devices includes a main control unit (not shown) installed at a designated position of the structure, and a subsidiary control unit 142 installed on the corresponding transport unit 120 for controlling the movement of the corresponding transport unit 120 and the operation of the corresponding lighting devices 130.

Differing from the first embodiment, the guide rail 111 is made of a steel material having a C-shaped section, the lower surface of which is opened. A plurality of the trolley bars 113a to 113h are arranged in series on the opened lower surface of the guide rail 111 by the insulators 114.

The carbon brush collectors 124 are arranged in series corresponding to the trolley bars 113a to 113h, which are arranged in series. These arrangements of the trolley bars 113a to 113h and the carbon brush collectors 124 allow the lighting system of the present invention to have a low height.

Other parts of the lighting system of the second embodiment are substantially the same as those of the lighting system of the first embodiment, and a detailed description thereof will thus be omitted.

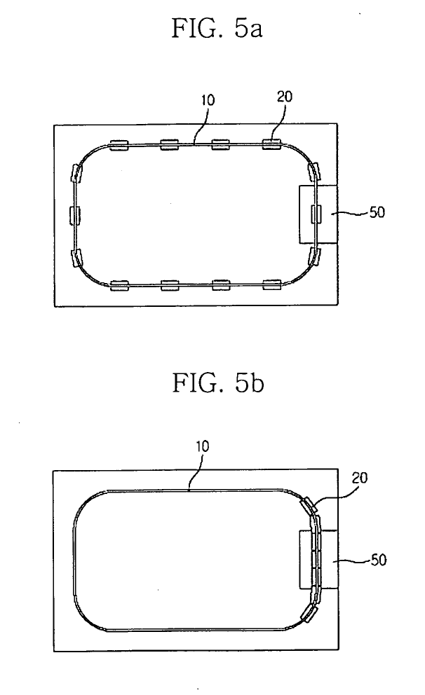

FIGS. 5A and 5B are schematic views respectively illustrating the track-movable lighting systems of the present invention, which are applied to gymnasiums. FIG. 5A illustrates the track-movable lighting system, in which transport units, each having a lighting device installed thereon, are spaced from each other by a designated interval on a track, and FIG. 5B illustrates the track-movable lighting system, in which transport units, each having a lighting device installed thereon, are gathered. That is, in accordance with the present invention, if necessary, the transport units 20 are properly arranged.

Although FIGS. 5A and 5B illustrate the track having a closed curved shape installed inside a structure, the shape of the track may be modified according to various requirements, such as size, construction, and required intensity of illumination of the structure.

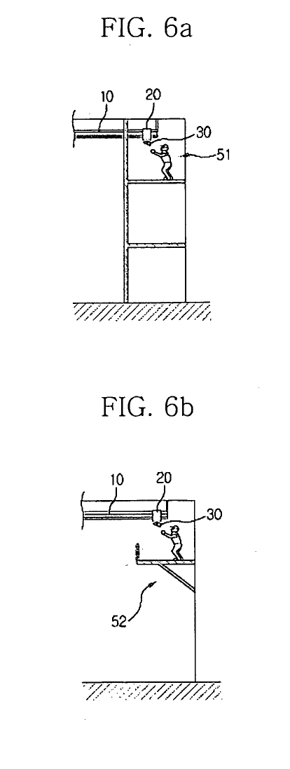

Further, as shown FIGS. 6A and 6B, the track-movable lighting system of the present invention further comprises an equipment 50 for maintaining and cleaning the lighting devices. The equipment 50 may be installed at a designated position inside or outside the structure so long as the track 10 is installed. The equipment 50 may be a separate space 51 installed in the structure, such as an operating chamber or a machinery chamber, as shown in FIG. 6A, or a handrail structure 52 temporarily installed at a wall of the structure.

In the case that the track-movable lighting system of the present invention comprises the equipment 50 for maintaining and cleaning the lighting devices as described above, it is possible to conveniently perform a maintenance or cleaning process of the lighting devices or to assure worker safety.

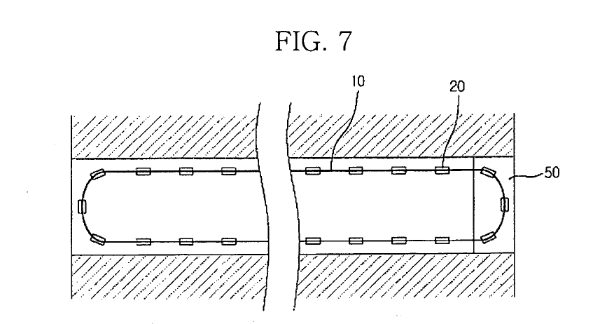

FIG. 7 is a schematic view illustrating the track-movable lighting system of the present invention applied to a tunnel. In the same manner as those shown in FIGS. 5A and 5B, the track-movable lighting system of FIG. 7 further comprises the equipment 50 for maintaining and cleaning the lighting devices.

However, in the case that the track-movable lighting system of the present invention is installed in an environment containing a large quantity of dust, such as a tunnel, it is preferable in terms of energy efficiency that the cleaning of the lighting devices is more frequently performed. Accordingly, an automatic light washer (not shown) may be installed in the equipment 50, so that the transport units 20 are moved at a designated time interval to wash the lighting devices of the transport units 20. Here, the automatic light washer may have any constitution so long as the automatic light washer can wash the lighting devices automatically, and a detailed description thereof will thus be omitted.

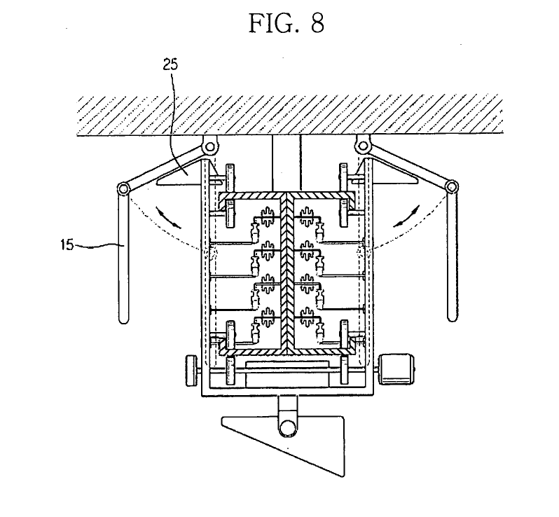

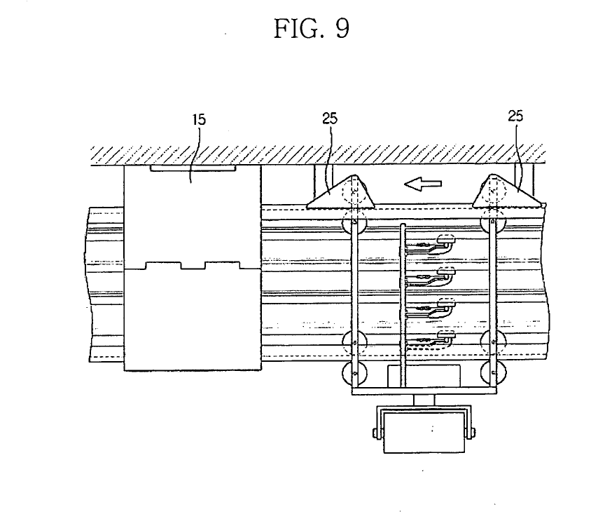

Further, in the case that the track-movable lighting system of the present invention is installed in an environment containing a large quantity of dust, or is installed outdoors, as shown in FIGS. 8 and 9, a plurality of dust protective covers for preventing the track from being contaminated by dust are continuously installed along the track.

Each of the dust protective covers is made of at least one hinge and a plate member, and is opened by guide protrusions 25 attached to the transport units 20 only when the transport units 20 pass and is closed under normal circumstances.

### INDUSTRIAL APPLICABILITY

As apparent from the above description, the present invention provides a track-movable lighting system, which moves lighting devices installed on transparent units along a track having a guide rail installed on a ceiling of a structure and a plurality of trolley bars, and has an equipment for allowing a worker to repair and clean the lighting devices at a designated position in the structure, thereby supplying convenience in maintenance of the lighting devices to the worker and reducing energy consumption rate due to the reduction in the number of the lighting devices.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A track-movable lighting system comprising:
a track fixedly installed on a ceiling of a structure;
a plurality of transport units installed on the track so that the transport units can move along the track by means of motors;
lighting devices respectively installed on the transport units so that the lighting devices can move together with the movement of the transport units; and
control devices for respectively controlling the movement of the corresponding transport units and the operation of the corresponding lighting devices,
wherein:
the track includes a guide rail fixed to the ceiling of the structure by a fixing member, and a plurality of trolley bars installed on the guide rail through insulators;
Each of the transport units includes a frame having a plurality of wheels, a motor installed on the frame for driving the wheels, a collector for transmitting electric power or a data signal, flowing along the trolley bars, to the transport unit, and an encoder for calculating the moving distance of the transport unit by means of the motor; and
Each of the control devices includes a main control unit installed at a designated position of the structure, and a subsidiary control unit installed on the corresponding transport unit for controlling the movement of the corresponding one of transport units and the operation of the corresponding one of the lighting devices.

2. The track-movable lighting system as set forth in claim 1,
wherein several trolley bars of the plural trolley bars serve as electric power lines for supplying electric power of a designated voltage to the motor of the transport unit and the lighting device, other several trolley bars of the plural trolley bars serve as data communication lines for allowing the main control unit and the subsidiary control unit of the control device to communicate with each other, and remaining several trolley bars of the plural trolley bars serve as DC power supply lines for supplying DC power to the subsidiary control unit.

3. The track-movable lighting system as set forth in claim 1, wherein the collector includes:
a slide member sliding by electrical contact with the corresponding one of the trolley bars;
a support member for supporting the slide member to the frame of the transport unit;
a conductive wire for electrically connecting the slide member and the transport unit so that the electric power or the data signal is transmitted therebetween; and
an elastic member for pressing the slide member so that the slide member firmly contacts the corresponding one of the trolley bars.

4. The track-movable lighting system as set forth in claim 1, wherein:
the guide rail has an approximately I-shaped section; and
the trolley bars are arranged in parallel at both sides of the guide rail.

5. The track-movable lighting system as set forth in claim 1, wherein:
the guide rail, the lower surface of which is opened, is extended in a transverse direction, and has an approximately C-shaped section; and
the trolley bars are arranged in series on the opened lower surface of the guide rail by the insulators.

6. The track-movable lighting system as set forth in claim 1,
wherein each of the control devices further includes a personal computer for monitoring data of the corresponding transparent unit and the corresponding lighting device and controlling the operation of the corresponding transparent unit and lighting device through the main control unit and the subsidiary control unit.

7. The track-movable lighting system as set forth in claim 1,
wherein a plurality of the transparent units installed on the track are independently controlled by the corresponding control devices.

8. The track-movable lighting system as set forth in claim 1,
wherein each of the lighting devices is rotated such that the angle of the lighting device can be vertically and horizontally adjusted by the corresponding control device.

9. The track-movable lighting system as set forth in claim 1, further comprising an equipment for maintaining and cleaning the lighting devices,
wherein the equipment is a separate space in the structure, or a handrail structure temporarily installed at a wall of the structure.

10. The track-movable lighting system as set forth in claim 9,
wherein an automatic light washer is installed in the equipment, so that the transport units are moved at a designated time interval to wash the lighting devices of the transport units using the automatic light washer.

11. The track-movable lighting system as set forth in claim 1, further comprising a plurality of dust protective covers continuously installed along the track, such that the dust protective covers are opened and closed, for preventing the track from being contaminated by dust,
wherein the dust protective covers are opened by guide protrusions attached to the transport units only when the transport units pass, and are closed under the normal circumstances.
